(19) United States
(12) Patent Application Publication
(10) Pub. No.: US 2026/0051235 A1
(43) Pub. Date: Feb. 19, 2026

(54) FALL RISK DETECTION SENSOR

(71) Applicant: Gentex Corporation, Zeeland, MI (US)

(72) Inventors: Thomas S. Wright, Hamilton, MI (US); Eric P. Bigoness, Ada, MI (US); Andrew D. Weller, Holland, MI (US); Jacob A. Vanden Bosch, Grand Rapids, MI (US)

(73) Assignee: Gentex Corporation, Zeeland, MI (US)

(21) Appl. No.: 19/297,237

(22) Filed: Aug. 12, 2025

Related U.S. Application Data
(60) Provisional application No. 63/682,886, filed on Aug. 14, 2024.

(51) Int. Cl. G08B 21/04; G08B 1/08; G08B 3/10

(52) U.S. Cl. CPC G08B 21/043; G08B 1/08; G08B 3/10; G08B 21/0469; G08B 21/0492

(57) ABSTRACT

An environmental monitoring system includes at least one sensor module. The at least one sensor module includes a housing, a power receiving module, a communication module, and at least one sensor. The at least one sensor is configured to detect a presence an occupant in the environment. A control system is configured to receive the detected presence from the at least one sensor over a first period of time to determine a movement velocity of the patient, detect abnormalities of the movement velocity of the occupant over a second period of time, and generate a notification of irregular travel.

### CROSS-REFERENCE TO RELATED APPLICATION

This application claims priority to and the benefit under 35 U.S.C. § 119(e) of U.S. Provisional Application No. 63/682,886, filed on Aug. 14, 2024, entitled “FALL RISK DETECTION SENSOR,” the disclosure of which is hereby incorporated herein by reference in its entirety.

### FIELD OF THE DISCLOSURE

The present disclosure generally relates to a system including one or more modules that detect activities around an environment, including obstructions in walk paths, travel profiles of occupants, and other potential fall conditions.

### SUMMARY OF THE DISCLOSURE

According to an aspect of the present disclosure, a system of monitoring an environment includes at least one sensor module. The at least one sensor module includes a housing, a power receiving module, a communication module, and at least one sensor. The at least one sensor is configured to detect a presence of an occupant in the environment. A control system is configured to receive the detected presence from the at least one sensor over a first period of time to determine a movement velocity of the patient, detect abnormalities of the movement velocity of the occupant over a second period of time, and generate a notification of irregular travel.

According to another aspect, the at least one sensor includes at least two sensors, and a control system is configured to, based on repeated detected presence and movement velocity at the at least two sensors, develop a movement profile of an occupant that includes an estimated movement velocity threshold. If the occupant exhibits a movement velocity outside of the estimated movement velocity threshold, a notification of irregular travel is generated.

According to still another aspect, a control system is configured to initially measure a baseline distance between at least two sensors and an opposing surface of an environment, detect changes to the baseline distance indicating the presence of an object in a path of travel, and generate a notification of the object.

The present disclosure generally provides a system of monitoring an environment that includes at least one sensor module. The at least sensor module is capable of detecting activities around an environment, including obstructions in walk paths, travel profiles of occupants, and other potential fall conditions. These detected activities can be utilized to maintain a safe environment for occupants, including occupants susceptible to falls and/or occupants who more generally benefit from environmental monitoring.

These and other features, advantages, and objects of the present disclosure will be further understood and appreciated by those skilled in the art by reference to the following specification, claims, and appended drawings.

### BRIEF DESCRIPTION OF THE DRAWINGS

In the drawings:

FIG. 1A is a top, plan view of a monitoring system within an environment, according to an aspect of the present disclosure;

FIG. 1B is an upper perspective view of the environment incorporating several sensor modules with different operational principles, according to an aspect of the present disclosure;

FIG. 2 is a schematic view of a plurality of sensor modules in communication with each other and a hub, according to an aspect of the present disclosure;

FIG. 3A is a front schematic view of a sensor module of a first construction, according to an aspect of the present disclosure;

FIG. 3B is a front perspective view of a sensor module of a second construction, according to an aspect of the present disclosure;

FIG. 3C is a front perspective view of a sensor module of a third construction, according to an aspect of the present disclosure;

FIG. 3D is a front perspective view of a sensor module of a fourth construction, according to an aspect of the present disclosure;

FIG. 4 is a control system regulating activities of one or more sensor modules, according to an aspect of the present disclosure;

FIG. 5A is a graphical illustration of a sudden change in movement velocity of an occupant between one or more sensor modules, according to an aspect of the disclosure;

FIG. 5B is a graphical illustration of location-based tracking of an occupant between one or more sensor modules, according to an aspect of the disclosure; and

FIG. 5C is a graphical illustration of the dwell time of an occupant in a location between one or more sensor modules, according to an aspect of the disclosure.

### DETAILED DESCRIPTION

The present illustrated embodiments reside primarily in combinations of method steps and apparatus components related to a system including one or more modules that detect activities around an environment, including obstructions in walk paths, travel profiles of occupants, and other potential fall conditions. Accordingly, the apparatus components and method steps have been represented, where appropriate, by conventional symbols in the drawings, showing only those specific details that are pertinent to understanding the embodiments of the present disclosure so as not to obscure the disclosure with details that will be readily apparent to those of ordinary skill in the art having the benefit of the description herein. Further, like numerals in the description and drawings represent like elements.

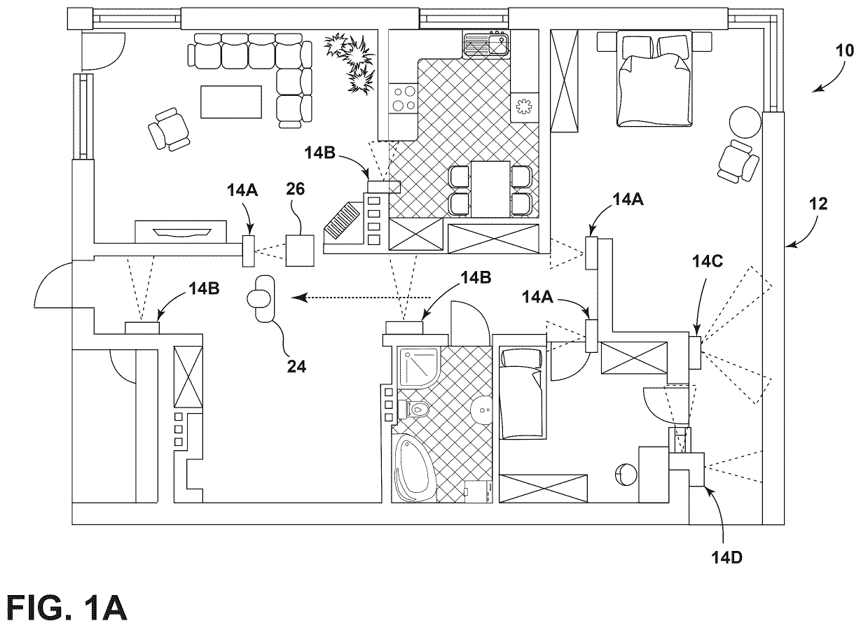

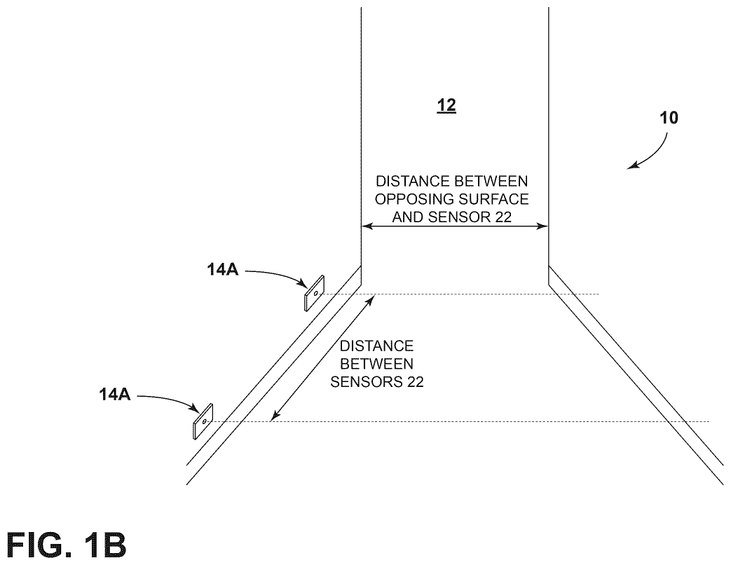

For purposes of description herein, the terms “upper,” “lower,” “right,” “left,” “rear,” “front,” “vertical,” “horizontal,” and derivatives thereof, shall relate to the disclosure as oriented in FIG. 1A. Unless stated otherwise, the term “front” shall refer to the surface of the device closer to an intended viewer of the device, and the term “rear” shall refer to the surface of the device further from the intended viewer of the device. However, it is to be understood that the disclosure may assume various alternative orientations, except where expressly specified to the contrary. It is also to be understood that the specific devices and processes illustrated in the attached drawings, and described in the following specification, are simply exemplary embodiments of the inventive concepts defined in the appended claims. Hence, specific dimensions and other physical characteristics relating to the embodiments disclosed herein are not to be considered as limiting, unless the claims expressly state otherwise.

The terms “including,” “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises a . . .” does not, without more constraints, preclude the existence of additional identical elements in the process, method, article, or apparatus that comprises the element.

Referring initially to FIGS. 1A-3A, a system of monitoring an environment 12 is designated by reference numeral 10. The system 10 includes at least one sensor module 14A. The at least one sensor module 14A includes a housing 16, a power receiving module 18, a communication module 20, and at least one sensor 22. The at least one sensor 22 is configured to detect a presence of an occupant 24 in the environment 12. A control system 100 is configured to receive the detected presence from the at least one sensor 22 over a first period of time (e.g., days, weeks, months) to determine a movement velocity of the patient, detect abnormalities of the movement velocity of the occupant 24 over a second period of time (e.g., gradual or sudden), and generate a notification of irregular travel.

With continued reference to FIGS. 1A-3A, the system 10 detects activities around the environment 12, including changes or objects 26 of walk paths, hallways, and other potential fall conditions, such as detectable changes in the movement velocity of the occupant 24. More particularly, the system 10 may be based on repeated detected presence and movement velocity of the occupant 24 within the environment 12. The system 10 may utilize the repeated detected presence and movement velocity of the occupant 24 within the environment 12 to develop a movement profile of the occupant 24 that includes an estimated movement velocity threshold. If the occupant 24 exhibits a movement velocity outside of the estimated movement velocity threshold, the notification of irregular travel may be generated. More particularly, in home healthcare systems where the occupant 24 is monitored at home, at nursing homes, in medical environments, and in other environments, metric data gathering of traversal speeds, and utilization of the occupant's 24 activities can be beneficial to ensure the health of the occupant 24. For example, once the movement profile of the occupant 24 is developed, irregular activities, changes in movement velocity (e.g., trends or sudden) beyond the estimated movement velocity threshold, and/or other irregularities to the movement profile can be utilized to determine that the occupant 24 has deteriorating health or a sudden accident or health crisis. As will be described in greater detail below, in addition to monitoring trends of occupant 24 travel, the monitoring system 10 may further detect conditions, such as objects along a path of travel and/or the like that may be potentially hazardous to the occupant 24 (e.g., via tripping). While the monitoring system 10 may be utilized in any type of environment 12 and for monitoring any type of occupant 24, the monitoring system 10 may be particularly beneficial for occupants with health conditions that need to be monitored. For example, occupants 24 who are disabled, elderly, blind, have Alzheimer's, and/or other neurodegenerative disorders may be monitored for irregularities in travel and/or conditions that may be potentially hazardous to the occupant 24. In this manner, the monitoring system 10 may be utilized to monitor and track the occupant 24 in healthcare environments, assisted living environments, or to prolong independent living. When an irregularity and/or abnormality is detected, control system 100 may generate a notification to the occupant themselves, or a caregiver, such as a healthcare worker or system, and/or a family member or friend that has agreed to undertake some level of responsibility to the occupant 24.

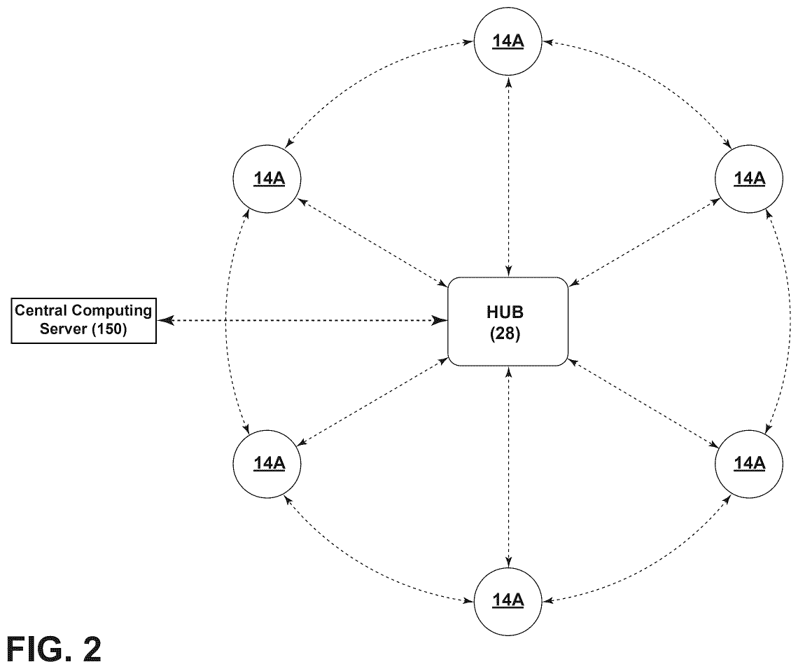

With reference now specifically to FIGS. 1A-2, the at least one sensor 22 may include a plurality of sensors 22 (two, three, four, or more), located in the housing 16. Likewise, the at least one sensor module 14A may include a plurality of sensor modules 14A distributed around the environment 12, each sensor module 14A may include a single or a plurality of the sensors 22. Obtaining metric data, therefore, may be accomplished by, for example, a single sensor module 14A with a single sensor 22, a single sensor module 14A with a plurality of sensors 22, or a plurality of sensor modules 14A each with a single and/or a plurality of sensors 22. When a single sensor 22 is utilized in each sensor module 14A, multiple sensor modules 14A may be needed to determine movement velocity. When a plurality of the sensor modules 14A is utilized, each sensor module 14A may be in communication with one, more, or each of the other sensor modules 14A via the communication modules 20. Further, one, more, or each of the sensor modules 14A may be in communication with a hub 28 that receives and/or transmits the metric data from one, more, or each sensor modules 14A.

The communication between components may be wireless, for example, via a Wi-Fi network, a cellular network, Bluetooth, NearLink, near-field communication (NFC), LPWAN, ultra-wideband (UWB) and IEEE 802.15. 4, other short-range communication network, the like, and/or combinations thereof. However, in other implementations, the communication between components may be wired and/or a combination of wired and wireless. As will be described in greater detail below, the control system 100 may include components in the one or more sensor modules 14A, the hub 28, or combinations thereof.

With continued reference to FIGS. 1A-2, the system 10 (e.g., the control system 100) may be configured to initially (e.g., when installed) measure a baseline distance between one of the sensor modules 14A and an opposing surface of the environment 12 (e.g., a distance across a hallway or room). The system 10 may further be configured to detect changes to the baseline distance indicating the presence of an object 26 in a path of travel (e.g., the hallway or room) or a change in the distance between the opposing surface (e.g., rearrangement of furniture). For example, over the course of time, objects 26, such as bags, chairs, clothes, and other objects may be left within the path of travel intentionally or unintentionally. The control system 100 may be configured to determine if the object 26 poses a risk of obstructing the occupant's traversal through the path of travel (e.g., potentially causing the occupant 24 to trip) and, if so, generate a notification of the object 26. In other scenarios, the occupant 24 may fall and/or otherwise be located proximate the sensor module 14A for extended periods of time, indicating negative health conditions. The control system 100 may be configured to distinguish between the object 26 and the occupant 24 (e.g., based on movement of arms or other body parts) and generate the notification and/or alert of an appropriate caregiver. As best depicted in FIG. 1B, the sensor modules 14A may be configured to attach close to a floor of the environment 12 (e.g., at wall outlets) for monitoring lower portions of the environment 12, objects 26 proximate the floor, and lower body portions of the occupant 24.

The notification may be generated on the sensor modules 14A, the hub 28, and/or any other device in communication with the system 10. For example, each sensor module 14A may include an alert module 30, such as an alert light, an audible element (e.g., a speaker), and/or the like that may be used to notify the occupant 24 when conditions are detected related to the occupant's motion velocity or the presence of objects 26. In some scenarios, the alert module 30 may be configurable to generate an audible alert for occupants with poor vision and/or in otherwise low light or other low visibility scenarios. For example, if the occupant 24 is approaching a sensor 22 proximate a detected object 26 (e.g., from another sensor 22), the control system 100 may generate an audible alert and/or otherwise illuminate the environment 12 to warn the occupant 24 of the presence of the object 26. The hub 28 may be local or remote to the environment 12 and may itself be configured to generate the notification (e.g., visually or audibly). In some embodiments, the hub 28 and/or sensor modules 14A may be in communication with a central computing server 150 that may be configured to generate the notification (e.g., visually or audibly). For example, the hub 28 and/or central computing server 150 may be associated with a remote caregiver service (e.g., in home health care), a facility service (e.g., a computing system at a nursing home or other medical environment), a mobile device (e.g., of the occupant 24 or a person responsible for monitoring the occupant 24). In this manner, the system 10 may provide notifications to the occupant 24 themselves and/or to caregivers that are local or remote from the environment 12.

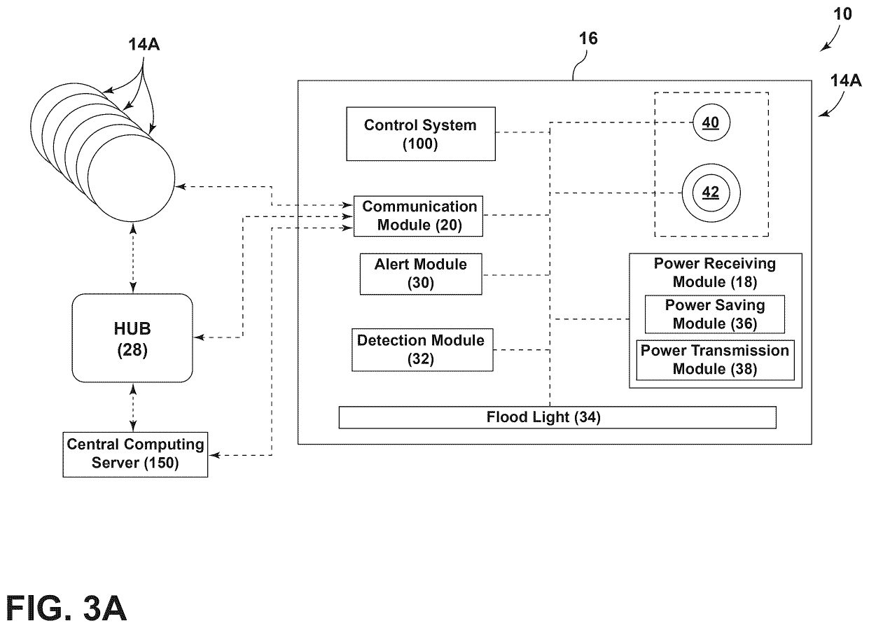

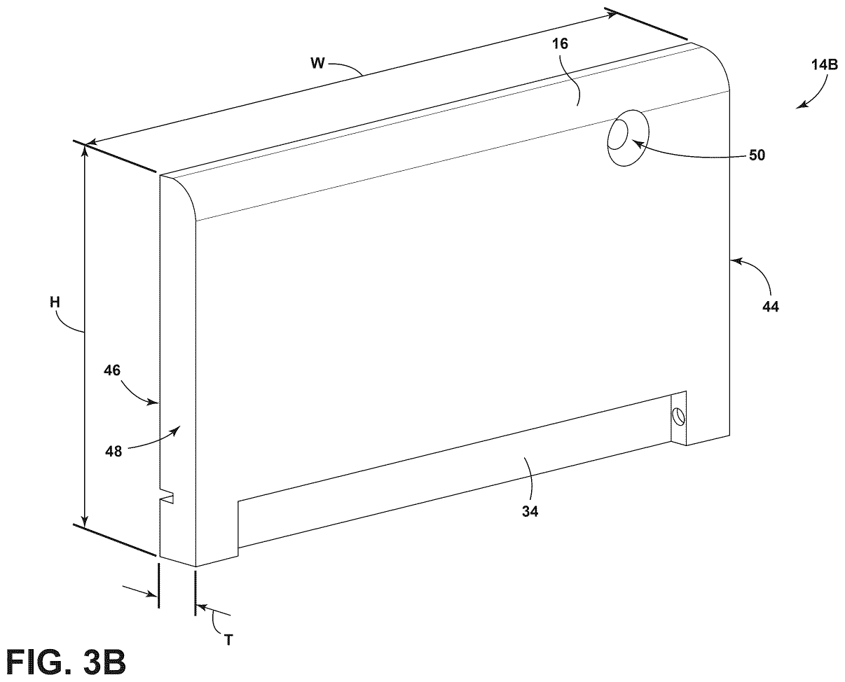

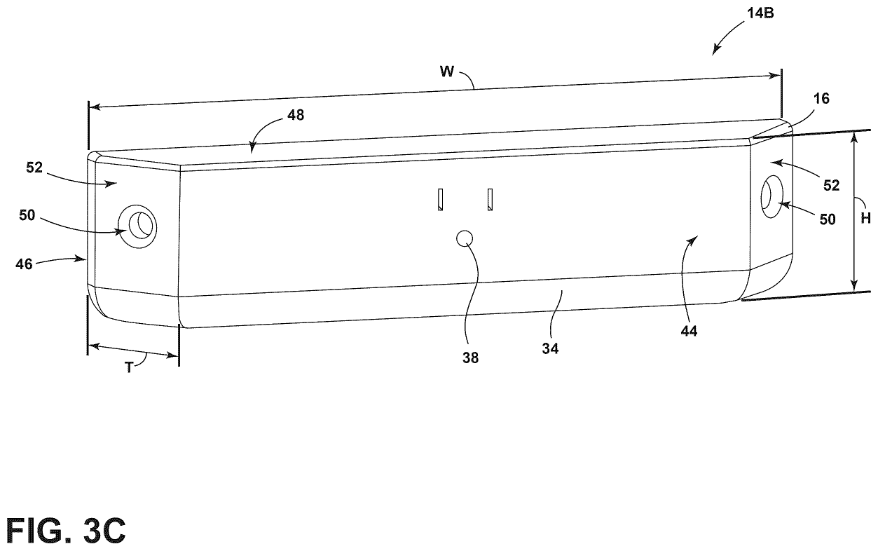

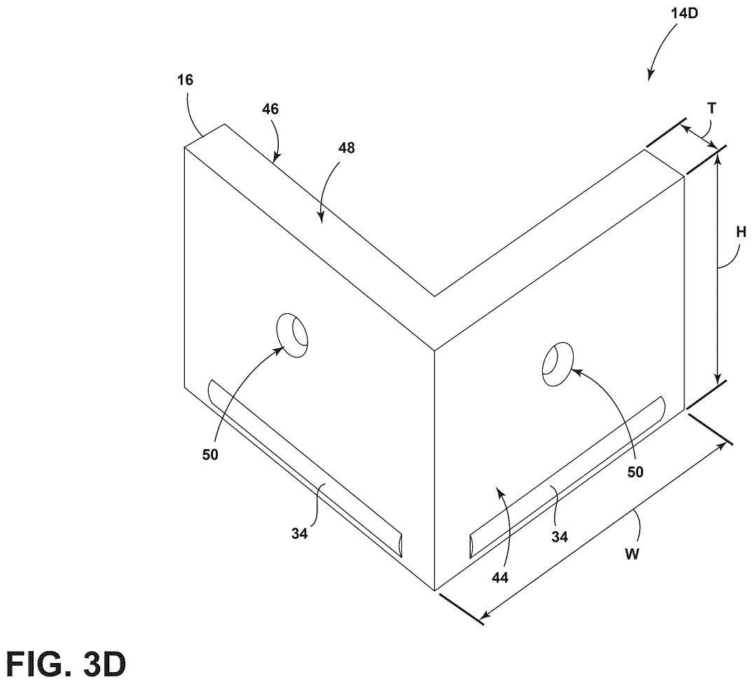

With reference now to FIG. 3A, the sensor module 14A may include various components located within the housing 16. For example, the power receiving module 18, the communication module 20, the at least one sensor 22, and the alert module 30 may be located within the housing 16. In addition, the sensor module 14A may include a detector module 32 with one or more detectors each configured to detect one or more of the presence of the occupant 24, an ambient light level, a power receiving status, and/or an audible input. The detection module 32 may be configured to trigger a flood light 34 that illuminates the environment when ambient light is below a threshold level and/or when the occupant 24 is in close proximity to the sensor module 14A. In some embodiments, the detection module may, for example, be configured to detect the occupant's 24 voice. In this manner, if the occupant 24 falls, the occupant 24 may be able to use voice commands, like a key phrase, such as “help me” and generate a notification and/or alert to an appropriate caregiver. The power receiving module 18 may include a current or power input, for example, for directly plugging into a wall outlet. The power receiving module 18 may further include a power saving module 36, for example, a battery charged by the current or power input. In this manner, in the event of a power outage, the sensor module 14A may continue to operate. In some embodiments, the detection module 32 may detect the power receiving status is off (i.e., that the sensor module 14A is not receiving power from the power receiving module 18) and switch the sensor module 14A to the power saving module 36. In some embodiments, the power receiving module 18 may include and/or be in operable communication with a power transmission module 38 (e.g., an outlet) for powering additional electronic devices through the power receiving module 18 and/or the power saving module 36. In some implementations, if the power receiving status is off, a notification may be generated to an appropriate caregiver and/or the occupant 24 themself.

With continued reference to FIG. 3A, the sensor 22 may be configured to operate under a variety of operational principles. For example, the sensor 22 may include a light source 40 and an imager module 42. The light source 40 may be configured to generate a structured light and the imager module 42 may be configured to detect changes in the structured light for operation under the principles of Time-of-Flight (“ToF”). The principles of ToF may be particularly beneficial in some scenarios, as ToF sensors can be used to measure distances between the sensor module 14A and an opposing surface in the environment 12. In some embodiments, the sensor 22 is configured as a single pixel ToF sensor, such that the detection of the occupant 24 or the object 26 is a datum point from a single detectable change. In such embodiments, utilizing two or more sensors 22 may be necessary for detecting the movement velocity of the occupant. Further, when structured light is utilized, changes in speckle content of the one or more light spots or captured pixels thereof can be utilized (e.g., via the control system 100) to determine movements in the micro and/or microradian scale. The changes in speckle content may be associated with determining biometric information such as breath rates, heart rates, and/or the like. When one of the biometric readings is abnormal (e.g., outside of a threshold), the control system 100 may generate a notification as described above. However, it should be appreciated that the sensor 22 may operate under different operating principles, for example, the sensor 22 may be configured as an ultrasonic sensor, a narrow field passive infrared (“PIR”) motion sensor, other configurations, the like, and/or combinations thereof.

The system 10 (e.g., the control system 100) may be configured to initially measure and/or detect a distance between the two sensors or more sensors. Therefore, in operation, when the occupant 24 is detected at a first one of the sensors 22, the control system 100 may be configured to initiate a count that ends when the occupant 24 is detected at a second one of the sensors 22. In this manner, the time it takes for the occupant 24 to traverse between the first and second sensors 22 can be utilized, in view of the distance between the first and second sensors, to determine the movement velocity. Likewise, once the count has ended, a second count may be initiated until the occupant 24 is detected back at the first one of the sensors 22 or a third one of the sensors 22. As such, metric data can be continually gathered in developing the estimated movement velocity threshold and other trends of occupant 24 travel paths and the most traveled areas of the environment 12.

With reference now to FIG. 3B, a sensor module 14B of a second construction is depicted. Unless otherwise explicitly stated, the sensor module 14B of the second construction may share all the same features, elements, functionalities, variations, detection principles, and communication schemes as the sensor module 14A of the first construction. For purposes of brevity, like elements between the various constructions share the same reference number designations as those previously described in reference to FIGS. 1A-3A. More particularly, the sensor module 14B includes housing 16 and a single sensor 22 located in the housing. The housing 16 includes a front face 44 and a rear face 46 spaced from the front face 44 via a sidewall 48. The front face 44 may define at least one aperture 50 aligned with the sensor 22 and the rear face 46 may define the connection for the power receiving module 18. The flood light 34 may be located proximate a bottom edge of the rear face 46 and oriented for illuminating, for example, the floor of the environment 12. The sidewall 48 defines a thickness T that is less than a width W and height H of the front and rear faces 44, 46. For example, the thickness T may be less than one or both of the width W and the height H by a factor of 2, 3, 4, 5, or more. In this manner, the sensor module 14B maintains a low profile against a wall of the environment 12.

With reference now to FIG. 3C, a sensor module 14C of a third construction is depicted. Unless otherwise explicitly stated, the sensor module 14C of the third construction may share all the same features, elements, functionalities, variations, detection principles, and communication schemes as the sensor module 14A of the first construction. For purposes of brevity, like elements between the various constructions share the same reference number designations as those previously described in reference to FIGS. 1A-3B. More particularly, the sensor module 14C includes housing 16 and a plurality of sensors 22 (e.g., two) located in the housing. The housing 16 includes a front face 44 and a rear face 46 spaced from the front face 44 via a sidewall 48. The front face 44 may define tapered surfaces 52 proximate side edges, and each tapered surface 52 may define at least one aperture 50 aligned with the sensor 22. The front face 44 may further define a connection for the power transmission module 38. The rear face 46 may define the connection for the power receiving module 18. The flood light 34 may be located proximate a bottom edge of the rear face 46 and oriented for illuminating, for example, the floor of the environment 12. The sidewall 48 defines a thickness T that is less than a width W of the front and rear faces 44, 46. For example, the thickness T may be less than the width W by a factor of 2, 3, 4, 5, or more. In this manner, the sensor module 14C maintains a low profile against a wall of the environment 12. The two sensors 22 may include a first sensor 22 oriented in a first direction and a second sensor 22 oriented in a second direction at least 15° to the first direction, for example, at least 15°, at least 20°, at least 25°, at least 30°, at least 35°, at least 40°, at least 45°, at least 50°, at least 55°, at least 60°, at least 65°, at least 75°, at least 85°, at least 90°, or at an obtuse angle. In this manner, the time it takes between the first sensor 22 detecting the occupant 24 and the second sensor 22 detecting the occupant 24, with the known distance between the first and second sensors 22 can be utilized in determining the movement velocity.

With reference now to FIG. 3D, a sensor module 14D of a fourth construction is depicted. Unless otherwise explicitly stated, the sensor module 14D of the fourth construction may share all the same features, elements, functionalities, variations, detection principles, and communication schemes as the sensor module 14A of the first construction. For purposes of brevity, like elements between the various constructions share the same reference number designations as those previously described in reference to FIGS. 1A-3C. More particularly, the sensor module 14D includes housing 16 and a plurality of sensors 22 (e.g., two) located in the housing. The housing 16 includes a front face 44 and a rear face 46 spaced from the front face 44 via a sidewall 48. The rear face 46 may define a connection for the power receiving module 18. The housing 16 may include an angled profile for locating between traverse walls of the environment 12. It should be appreciated that the angled profile may be inverted from that depicted in FIG. 3D. The sidewall 48 defines a thickness T that is less than a height H of the front and rear faces 44, 46. For example, the thickness T may be less than the height H by a factor of 2, 3, 4, 5, or more. In this manner, the sensor module 14D maintains a low profile against a corner between walls of the environment 12. The two sensors 22 may include a first sensor 22 oriented in a first direction and a second sensor 22 oriented in a second direction at least 15° to the first direction, for example, at least 15°, at least 20°, at least 25°, at least 30°, at least 35°, at least 40°, at least 45°, at least 50°, at least 55°, at least 60°, at least 65°, at least 75°, at least 85°, at least 90°, or at an obtuse angle. In this manner, the time it takes between the first sensor 22 detecting the occupant 24 and the second sensor 22 detecting the occupant 24, with the known distance between the first and second sensors 22 can be utilized in determining the movement velocity.

With reference now to FIGS. 3A-3D, it should be appreciated that the system 10 may employ several different constructions (e.g., two, more, or each construction) of the sensor modules 14A-14D within the same environment. Further, it should be appreciated that the low profile dimensions of the sensor modules 14A-14D permit integration with, for example, trim in the environment 12. Therefore, in some embodiments, the dimensions of the sensor modules 14A-14D (i.e., other than width) may be sized substantially equal to trim (for a substantially flush seating) within the environment 12 for seamless integration.

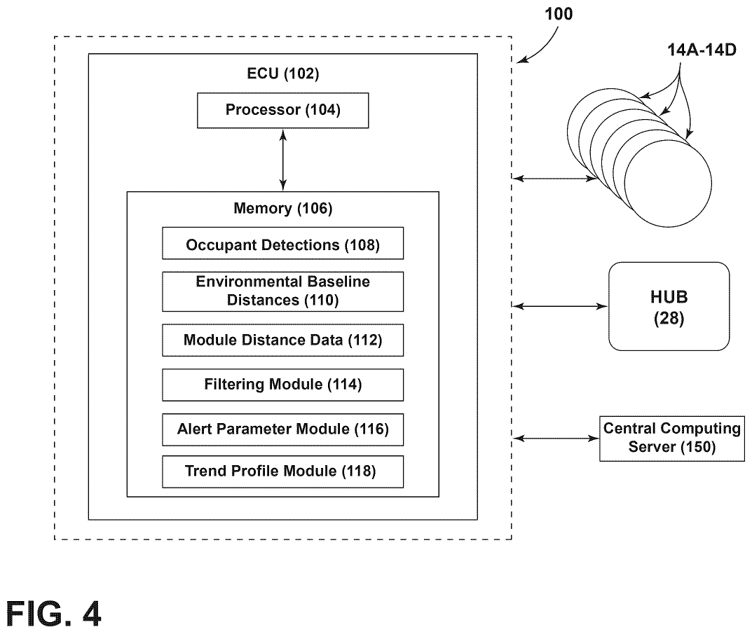

With reference now to FIG. 4, the control system 100 of the system 10 may include at least one electronic control unit (ECU) 102. The at least one ECU 102 may be located in the sensor module 14A-14D, the hub 28, the central computing server 150, and/or combinations thereof. The at least one ECU 102 may include the processor 104 and a memory 106. The processor 104 may include any suitable processor and/or microprocessor. Additionally, or alternatively, each ECU 102 may include any suitable number of processors, in addition to or other than the processor 104. The memory 106 may comprise a single disk or a plurality of disks (e.g., hard drives) and includes a storage management module that manages one or more partitions within the memory 106. In some embodiments, memory 106 may include flash memory, semiconductor (solid state) memory, or the like. The memory 106 may include Random Access Memory (RAM), a Read-Only Memory (ROM), Electrically Erasable Programmable Read-Only Memory (EEPROM), or a combination thereof. In some embodiments, an ESP32 micro-controller is utilized, with, for example, a built-in universal asynchronous receiver/transmitter (“UART”) may be associated with the communication module 20 for Wi-Fi and Bluetooth connectivity and the communication modules 20 may be configured for an ESP-NOW wireless communication protocol. The memory 106 may include instructions that, when executed by the processor 104, cause the processor 104 to, at least, perform the functions associated with the components of the system 10. The various components of the system 10 may, therefore, be controlled by the control system 100. The memory 106 may, therefore, include a series of occupant detections 108, environmental baseline distances 110 (e.g., distance between one of the sensor modules 14A-14D and an opposing surface of the environment), module distance data 112 (e.g., distances between two or more of the sensor modules 14A-14D), a filtering module 114, and an alert parameter module 116, and a trend profile module 118.

The series of occupant detections 108 may include a series of detections of the occupant associated with which sensor module 14A-14D has detected the occupant 24 and when the occupant 24 was detected. The environmental baseline distances 110 may include the initial baseline distance detected between one of the sensor modules 14A-14D and an opposing surface of the environment. The module distance data 112 may include distances between two or more of the sensor modules 14A-14D, which, in combination with the series of occupant detections 108 can be used to extrapolate the movement velocity of the occupant 24 and the estimated movement velocity threshold. In some embodiments, the series of occupant detections 108 may be periodically overwritten (e.g., weekly, monthly, etc.) as the movement velocity is extrapolated into metric data. The filtering module 114 may include protocols for cancelling certain metric data that is atypical of the movement velocity of the occupant 24. For example, the occupant 24 may have visitors or pets that travel at movement velocities distinct from the occupant 24 (e.g., outside of the movement velocity profile by a second threshold and/or multiple simultaneous or temporally proximate detections), in such instances, these data points can be discarded. The alert parameter module 116 may include threshold information on when to generate the notification or alert. For example, the alert parameter module 116 may include protocols for establishing the estimated movement velocity threshold, for example, how abnormal a movement velocity is before generating the notification or alert. The trend profile module 118 may include algorithms, machine learning modules, and/or other instructions for developing trend data, including the movement velocity profile, patterns in occupant travel paths (e.g., average trips to the restroom, time in bed, and/or the like). These trend profiles 118 may be compared to the detections for the presence of abnormalities (e.g., behavior outside of a predetermined threshold). In some implementations, the movement velocity profile is based, at least in part, on average movement velocity over an extended period of time (e.g., days, weeks, months) and/or readings (e.g., two or more movement velocities, three or more, four or more, ten or more, twenty of more, etc.).

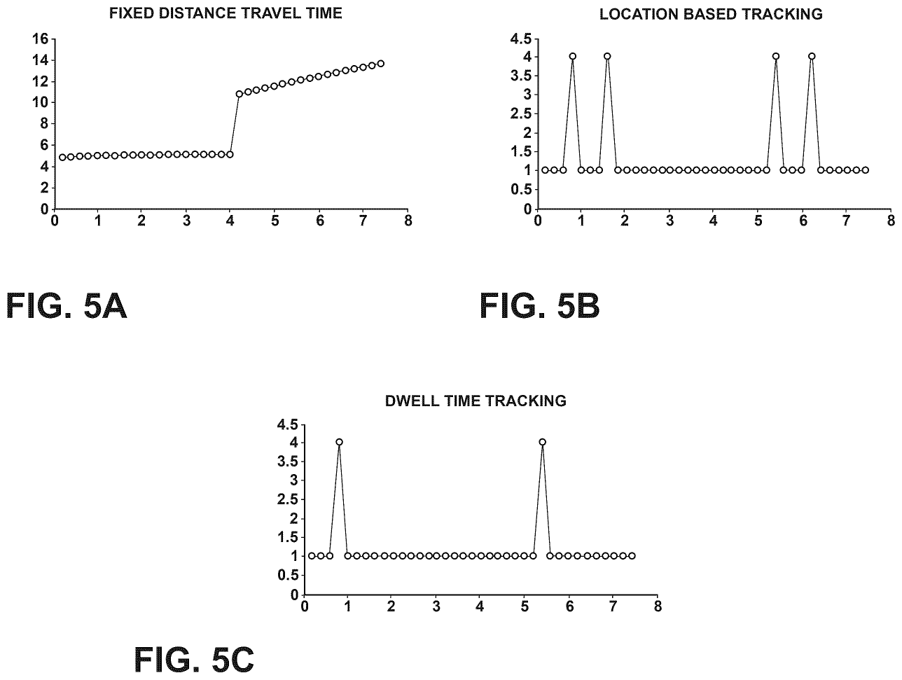

With reference to FIGS. 5A-5C graphical illustrations are provided to visualize the operational parameters of the system 10 according to an example implementation. More particularly, FIG. 5A is a graphical illustration of a sudden shift (i.e., abnormality) in the movement velocity of the occupant between one or more sensor modules 14A-14D. More particularly, FIG. 5A depicts a sudden decrease in detected/extrapolated movement velocities over a period of time, indicating that the occupant 24 is moving slower than usual. Such indications can be used to predict potential fall conditions and other negative health symptoms that can be reviewed and/or detected by the alert parameter module 116 facilitating the generation of the notification or alert. Further, it should be appreciated that the system 10 (e.g., the control system 100) may be configured to detect gradual changes in movement velocity (e.g., over days, weeks, or months). While a sudden change might indicate and injury has occurred, slower changes over time may indicate a worsening medical condition that needs to be addressed. The control system 100 may be configured to generate a notification and/or alert for both sudden and gradual changes. FIGS. 5B and 5C depict other potential functionalities of the system 10 in monitoring the occupant's 24 activities. More particularly, FIG. 5B is a graphical illustration of location-based tracking of an occupant between one or more sensor modules 14A-14D. Location-based tracking can be utilized, for example, to detect abnormal movements of the occupant 24, such as increased bathroom usage, abnormal sleep patterns, and/or the like. In some embodiments, the alert parameter module 116 may further be configured to detect these abnormalities in location traversal of the occupant 24 over time and generate the notification or alert. FIG. 5C is a graphical illustration of the dwell time of an occupant 24 in a location of the environment 12 between one or more sensor modules 14A-14D. For example, if the occupant 24 spends an abnormal amount of time in a particular room, such as the bathroom, kitchen, bedroom, living room, etc., the abnormal amount of time may be indicative of a negative health outcome or condition. In such instances, the alert parameter module 116 may further be configured to detect these abnormalities in dwell time over time and generate the notification or alert.

The disclosure herein is further summarized in the following paragraphs and is further characterized by combinations of any and all of the various aspects described therein.

According to one aspect of the present disclosure, a system of monitoring an environment includes at least one sensor module. The at least one sensor module includes a housing, a power receiving module, a communication module, and at least one sensor. The at least one sensor is configured to detect a presence of an occupant in the environment. A control system is configured to receive the detected presence from the at least one sensor over a first period of time to determine a movement velocity of the patient, detect abnormalities of the movement velocity of the occupant over a second period of time, and generate a notification of irregular travel.

According to yet another aspect, at least one sensor module includes a plurality of sensor modules, each sensor module including a single sensor.

According to still another aspect, the at least one sensor includes at least two sensors located in a housing.

According to another aspect, at least two sensors includes a first sensor oriented in a first direction and a second sensor oriented in a second direction at least 20° from the first direction.

According to yet another aspect, a sensor includes a structured light source and an imager module configured to operate under the principles of time of flight.

According to still another aspect, a control system is configured to initially measure a baseline distance between at least two sensors and an opposing surface of an environment, detect changes to the baseline distance indicating the presence of an object in a path of travel, and generate a notification of the object.

According to yet another aspect, a power receiving module includes a current input.

According to yet another aspect, a control system is configured to send a notification remotely to a caregiver's device.

According to still another aspect, a power saving module that includes a battery charged by a power receiving module.

According to yet another aspect, at least one sensor module includes a plurality of sensor modules, each sensor module in communication via the communication module.

According to still another aspect, each communication module is in further communication with a hub.

According to another aspect, a sensor is configured as one of an ultrasonic sensor or narrow field passive infrared (“PIR”) motion sensor.

According to yet another aspect, an abnormality includes a sudden decrease in the movement velocity.

According to still another aspect, at least one sensor includes at least two sensors, and a control system is configured to, based on a detected presence at one of the at least two sensors, estimate a time period when the occupant will pass a different one of the at least two sensors based on a movement velocity profile, and if the occupant does not pass the different one of the at least two sensors in the time period, generate the notification of irregular travel.

According to yet another aspect, at least one sensor includes at least two sensors, and a control system is configured to, based on repeated detected presence and movement velocity at the at least two sensors, develop a movement profile of an occupant that includes an estimated movement velocity threshold. If the occupant exhibits a movement velocity outside of the estimated movement velocity threshold, a notification of irregular travel is generated.

According to still another aspect, a flood illumination is configured to illuminate the environment based on at least one of ambient light levels or the presence of the occupant.

According to another aspect of the present disclosure, an environmental monitoring system includes a first sensor and a second sensor configured to detect a presence of an occupant in the environment. A control system is configured to receive the detected presence of the occupant from the first sensor and, after a period of time, the detected presence of the user from the second sensor. The control system is further configured to compare the period of time with a known distance between the first sensor and the second sensor to extrapolate a first movement velocity of the occupant, and continually receive the detected presence of the occupant from the first and second sensors after additional periods of time to extrapolate additional movement velocities. A movement velocity profile is developed by the control system with an estimated movement velocity threshold. The control system is further configured to compare a current movement velocity of the occupant with the estimated movement velocity threshold, and generate a notification of irregular travel if the current movement velocity of the occupant is outside of the estimated movement velocity threshold.

According to another aspect, the first and second sensors are located in a common housing of a sensor module.

According to another aspect of the present disclosure, an environmental monitoring system includes at least one sensor module that has a housing, and at least one sensor configured to detect a presence of an object or an occupant in an occupant path of travel. A control system is configured to receive the detected presence of an object from the at least one sensor, and generate a notification of a potential hazardous condition.

According to another aspect, the at least one sensor module includes an ambient light sensor, and the control system is further configured to illuminate the object upon a detected presence of the occupant when the ambient light level is below a threshold.

According to yet another aspect, the at least one sensor module includes a speaker, and the notification is generated audibly by the at least one sensor module upon a detected presence of the occupant.

It will be understood by one having ordinary skill in the art that construction of the described disclosure and other components is not limited to any specific material. Other exemplary embodiments of the disclosure disclosed herein may be formed from a wide variety of materials, unless described otherwise herein.

For purposes of this disclosure, the term “coupled” (in all of its forms, couple, coupling, coupled, etc.) generally means the joining of two components (electrical or mechanical) directly or indirectly to one another. Such joining may be stationary in nature or movable in nature. Such joining may be achieved with the two components (electrical or mechanical) and any additional intermediate members being integrally formed as a single unitary body with one another or with the two components. Such joining may be permanent in nature or may be removable or releasable in nature unless otherwise stated.

As used herein, the term “about” means that amounts, sizes, formulations, parameters, and other quantities and characteristics are not and need not be exact, but may be approximate and/or larger or smaller, as desired, reflecting tolerances, conversion factors, rounding off, measurement error and the like, and other factors known to those of skill in the art. When the term “about” is used in describing a value or an end-point of a range, the disclosure should be understood to include the specific value or end-point referred to. Whether or not a numerical value or end-point of a range in the specification recites “about,” the numerical value or end-point of a range is intended to include two embodiments: one modified by “about,” and one not modified by “about.” It will be further understood that the end-points of each of the ranges are significant both in relation to the other end-point, and independently of the other end-point.

The terms “substantial,” “substantially,” and variations thereof as used herein are intended to note that a described feature is equal or approximately equal to a value or description. For example, a “substantially planar” surface is intended to denote a surface that is planar or approximately planar. Moreover, “substantially” is intended to denote that two values are equal or approximately equal. In some embodiments, “substantially” may denote values within about 10% of each other, such as within about 5% of each other, or within about 2% of each other.

It is also important to note that the construction and arrangement of the elements of the disclosure, as shown in the exemplary embodiments, is illustrative only. Although only a few embodiments of the present innovations have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts, or elements shown as multiple parts may be integrally formed, the operation of the interfaces may be reversed or otherwise varied, the length or width of the structures and/or members or connectors or other elements of the system may be varied, and the nature or number of adjustment positions provided between the elements may be varied. It should be noted that the elements and/or assemblies of the system may be constructed from any of a wide variety of materials that provide sufficient strength or durability, in any of a wide variety of colors, textures, and combinations. Accordingly, all such modifications are intended to be included within the scope of the present innovations. Other substitutions, modifications, changes, and omissions may be made in the design, operating conditions, and arrangement of the desired and other exemplary embodiments without departing from the spirit of the present innovations.

It will be understood that any described processes or steps within described processes may be combined with other disclosed processes or steps to form structures within the scope of the present disclosure. The exemplary structures and processes disclosed herein are for illustrative purposes and are not to be construed as limiting.

It is also to be understood that variations and modifications can be made on the aforementioned structures and methods without departing from the concepts of the present disclosure, and further it is to be understood that such concepts are intended to be covered by the following claims unless these claims by their language expressly state otherwise.

What is claimed is:

1. An environmental monitoring system comprising:
at least one sensor module, comprising:
a housing;
a power receiving module;
a communication module;
at least one sensor configured to detect a presence of an occupant in the environment; and
a control system configured to:
receive the detected presence from the at least one sensor over a first period of time to determine a movement velocity of the patient;
detect abnormalities of the movement velocity of the occupant over second period of time; and
generate a notification of irregular travel.

2. The environmental monitoring system of claim 1, wherein the at least one sensor module includes a plurality of sensor modules, each sensor module including a single sensor.

3. The environmental monitoring system of claim 1, wherein the at least one sensor includes at least two sensors located in the housing.

4. The environmental monitoring system of claim 3, wherein the at least two sensors include a first sensor oriented in a first direction and a second sensor oriented in a second direction at least 20° from the first direction.

5. The environmental monitoring system of claim 1, wherein the sensor includes a structured light source and an imager module configured to operate under the principles of time of flight.

6. The environmental monitoring system of claim 1, wherein the control system is further configured to:
initially measure a baseline distance between the at least two sensors and an opposing surface of the environment;
detect changes to the baseline distance indicating the presence of an object in a path of travel; and
generate a notification of the object.

7. The environmental monitoring system of claim 1, wherein the control system is configured to send the notification remotely to a caregiver's device.

8. The environmental monitoring system of claim 7, further including a power saving module that includes a battery charged by the power receiving module.

9. The environmental monitoring system of claim 1, wherein the at least one sensor module includes a plurality of sensor modules, each sensor module in communication via the communication module.

10. The environmental monitoring system of claim 9, wherein each communication module is in further communication with a hub.

11. The environmental monitoring system of claim 1, wherein the sensor is configured as one of an ultrasonic sensor or narrow field passive infrared (“PIR”) motion sensor.

12. The environmental monitoring system of claim 1, wherein the abnormality includes a sudden decrease in the movement velocity.

13. The environmental monitoring system of claim 1, wherein at least one sensor includes at least two sensors, and the control system is further configured to:
based on the detected presence at one of the at least two sensors, estimate a time period when the occupant will pass a different one of the at least two sensors based on a movement velocity profile; and
if the occupant does not pass the different one of the at least two sensors in the time period, generate the notification of irregular travel.

14. The environmental monitoring system of claim 1, wherein at least one sensor includes at least two sensors, and the control system is further configured to:
based on repeated detected presence and movement velocity at the at least two sensors, develop a movement profile of the occupant that includes an estimated movement velocity threshold; and
if the occupant exhibits a movement velocity outside of the estimated movement velocity threshold, generate the notification of irregular travel.

15. The environmental monitoring system of claim 1, further including a flood illumination configured to illuminate the environment based on at least one of ambient light levels or the presence of the occupant.

16. An environmental monitoring system comprising:
a first sensor and a second sensor configured to detect a presence of an occupant in the environment; and
a control system configured to:
receive the detected presence of the occupant from the first sensor and, after a period of time, the detected presence of the user from the second sensor;
compare the period of time with a known distance between the first sensor and the second sensor to extrapolate a first movement velocity of the occupant;
continually receiving the detected presence of the occupant from the first and second sensors after additional periods of time to extrapolate additional movement velocities;
develop a movement velocity profile with an estimated movement velocity threshold;
compare a current movement velocity of the occupant with the estimated movement velocity threshold; and
generate a notification of irregular travel if the current movement velocity of the occupant is outside of the estimated movement velocity threshold.

17. The environmental monitoring system of claim 16, wherein the first and second sensors are located in a common housing of a sensor module.

18. An environmental monitoring system comprising:
at least one sensor module, comprising:
a housing;
at least one sensor configured to detect a presence of an object or an occupant in an occupant path of travel; and
a control system configured to:
receive the detected presence of an object from the at least one sensor; and
generate a notification of a potential hazardous condition.

19. The environmental monitoring system of claim 18, wherein the at least one sensor module includes an ambient light sensor, and the control system is further configured to illuminate the object upon a detected presence of the occupant when the ambient light level is below a threshold.

20. The environmental monitoring system of claim 18, wherein the at least one sensor module includes a speaker, and the notification is generated audibly by the at least one sensor module upon a detected presence of the occupant.
